(19) United States
(12) Patent Application Publication
(10) Pub. No.: US 2016/0299576 A1
(43) Pub. Date: Oct. 13, 2016

(54) AIR CONTROL INPUT APPARATUS AND METHOD

(71) Applicant: Chunsheng ZHU, Beijing (CN)

(72) Inventor: Chunsheng ZHU, Beijing (CN)

(21) Appl. No.: 15/031,557

(22) PCT Filed: Oct. 24, 2013
(86) PCT No.: PCT/CN2013/085912

§ 371 Date: Jun. 28, 2016

(51) Int. Cl. G06F 3/0346; G06F 3/0354; G06F 3/038; G06F 3/041

(52) U.S. Cl. CPC G06F 3/0346; G06F 3/0414; G06F 3/0354; G06F 3/038

(57) ABSTRACT

The disclosure relates to the technical field of computer peripherals, and provides an air hand control input device. The air hand control input device comprises a housing, an interface chip, a gyroscope, and an angular velocity processor, wherein the interface chip is arranged inside the housing for communication with a terminal equipment; the gyroscope is arranged inside the housing for collecting angular velocity values of the air hand control input device on the x-axis, y-axis, and z-axis of a three-dimensional space and transmitting an angular velocity signal containing the angular velocity values; and the angular velocity processor is arranged inside the housing and connected with the gyroscope and the interface chip for calculating an rotation angle on the xy plane, a three-dimensional rotation azimuth angle, and a three-dimensional rotation angle at the three-dimensional rotation azimuth angle of the air hand control input device, according to the angular velocity values contained in the angular velocity signal from the gyroscope and a sampling period of the gyroscope. The air hand control input device can not only realize the traditional two-dimensional control function, but also can realize the three-dimensional control of translation on three axes and angular rotation of a three-dimensional controlled part in the space, thus providing all-around control of two dimensions and three dimensions on the interface.

### TECHNICAL FIELD

The present disclosure relates to a peripheral equipment of a terminal equipment, and more particularly, to an air hand control input device and method.

### BACKGROUND

Since the launching, the computer has undergone a great many of technical innovations. For instance, computer's operation and control interface goes through the development from a command user interface to a graphical interface, then to a hot 3D interface by this time. The 3D interface can be likely to present the requirements of the user in a direct way as far as possible, bringing about favorable experience effects for the user. In the meantime, computer input equipment, including mouse and the like, have also been considered and developed recently.

An air mouse stands out as a milestone in the development history of the computer input equipment. The air mouse is not needed to be placed by an operator on any plane. Even placed in the air, the air mouse can also control a controlled object on the terminal interface based on the movement and click by the operator. This is free and convenient.

However, most of the existing air mice are used as a pointer, a remote control equipment and the like, but not really applied as the computer input equipment. Moreover, in some scenes, such as 3D game, 3D model building operation and the like, the interface needs to be subject to the all-around control in both two-dimension and three-dimension. As a result, the traditional air mice only controlling the vertical and horizontal displacement of the controlled object are unable to meet this requirement obviously.

### SUMMARY

### Technical Problem

The technical problem to be solved in the present disclosure is how to realize the two-dimensional control and three-dimensional control of a controlled object on a terminal interface by operating the mouse without a carrier.

### Solution

The embodiment of the present disclosure provides an air hand control input device, comprising: a housing, and an interface chip, arranged inside the housing for communication with a terminal equipment, wherein the air hand control input device further comprises: a gyroscope, arranged inside the housing for collecting angular velocity values of the air hand control input device on x-axis, y-axis, and z-axis of a three-dimensional space and transmitting an angular velocity signal containing the angular velocity values; and an angular velocity processor, arranged inside the housing and connected with the gyroscope and the interface chip, the angular velocity processor being adapted to calculate a rotation angle on the xy plane, a three-dimensional rotation azimuth angle, and a three-dimensional rotation angle at the three-dimensional rotation azimuth angle of the air hand control input device, according to the angular velocity values contained in the angular velocity signal from the gyroscope and a sampling period of the gyroscope.

The embodiment of the present disclosure further provides an air hand control input method, comprising the following steps of: collecting angular velocity values of an air hand control input device on x-axis, y-axis, and z-axis of a three-dimensional space via a gyroscope; and calculating a rotation angle on the xy plane, a three-dimensional rotation azimuth angle, and a three-dimensional rotation angle at the three-dimensional rotation azimuth angle of the air hand control input device, according to the angular velocity values and a sampling period of the gyroscope.

### Advantages Effects

The air hand control input device provided by the present disclosure can be operated in the air without a carrier. Both the device and method can not only realize the traditional two-dimensional control function, but also can realize the three-dimensional control of the controlled part, thus providing all-around control of two dimensions and three dimensions on the interface.

The other features and aspects of the present disclosure will become more apparent from the following detailed description for the exemplary embodiments when taken with reference to the accompanying drawings.

### BRIEF DESCRIPTION OF THE DRAWINGS

The drawings contained in the specification and formed as a part thereof, show the exemplary embodiments, features and aspects of the present disclosure with the specification together for explaining the theory therein.

FIG. 1 is a structure diagram of an air hand control input device provided by a first embodiment of the present disclosure;

FIG. 2 is a structure diagram of an air hand control input device provided by a second embodiment of the present disclosure;

FIG. 3 is a structure diagram of an air hand control input device provided by a third embodiment of the present disclosure;

FIG. 4 is a structure diagram of an air hand control input device provided by a fourth embodiment of the present disclosure;

FIG. 5 is a structure diagram of a gyroscope of one embodiment of the present disclosure; and

FIG. 6 is a schematic diagram of angular velocity of one embodiment of the present disclosure.

### REFERENCE LIST

11: left touch pressure signal collector; 12: right touch pressure signal collector; 2: touch pressure signal processor; 3: signal collecting switch; 41: accelerometer; 42: acceleration processor; 61: gyroscope; 62: angular velocity processor; 7: interface chip; 8: housing.

### DETAILED DESCRIPTION

Various exemplary embodiments, features and aspects of the present disclosure will be described in details with reference to the drawings hereinafter. The same drawing mark in the drawing indicates the element with the same or similar function. Unless otherwise stated specially, the drawing is unlikely to be drawn in spite of showing various aspects of the embodiment in the drawing.

The dedicated term “exemplary” here means “served as an example, embodiment or illustration”. Any embodiment illustrated as “exemplary” here is unlikely to be explained to be superior to or better than the other embodiments.

In addition, more concrete details are given in the description of the preferred embodiments hereinafter in order to better illustrate the present disclosure. Those skilled in the art should understand that the present disclosure may be implemented as well even if there are no some concrete details. In other some examples, the methods, means, elements and circuits well known by those skilled in the art are not described in details, thereby standing out the aim of the present disclosure.

### First Embodiment

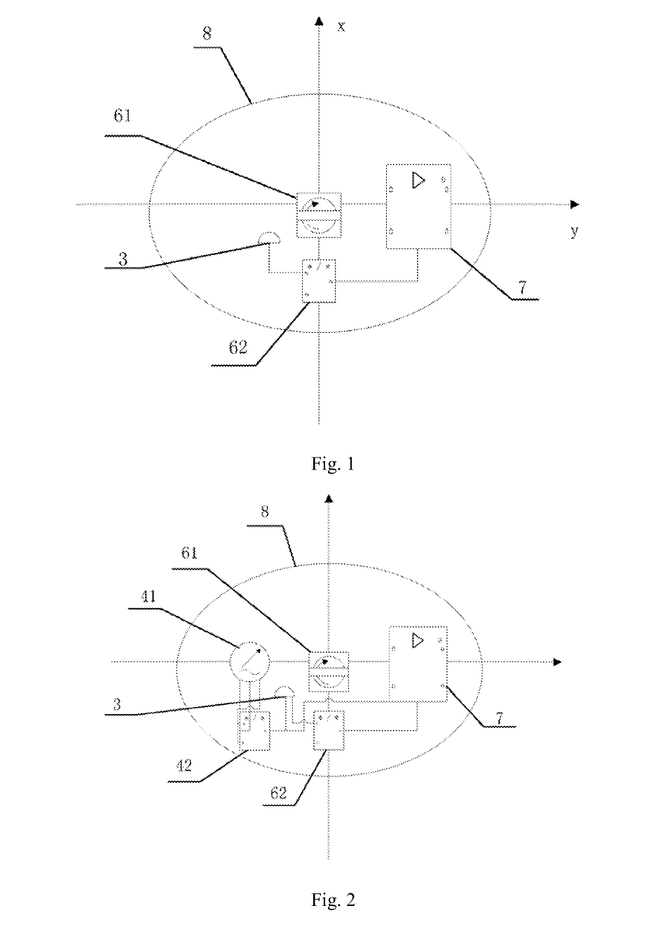

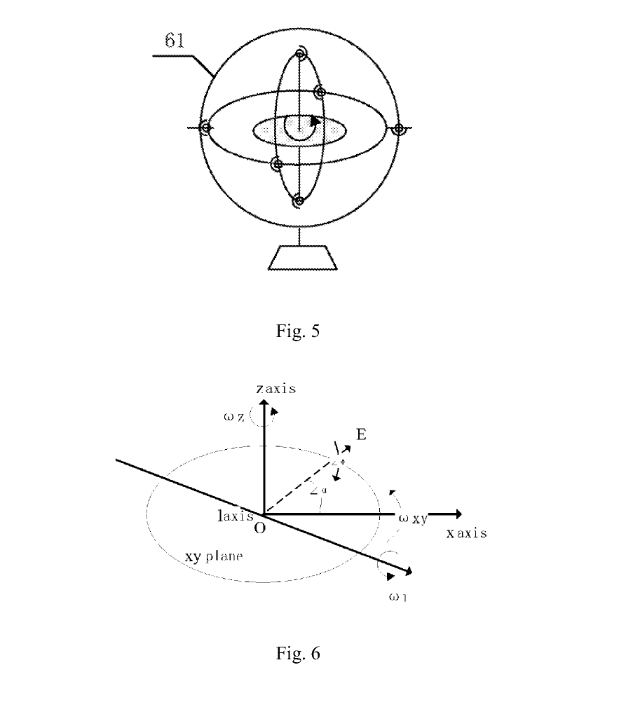

FIG. 1 is a structure diagram of an air hand control input device provided by a first embodiment of the present disclosure, FIG. 5 is a structure diagram of a gyroscope of one embodiment of the present disclosure, and FIG. 6 is a schematic diagram of angular velocity of one embodiment of the present disclosure.

As shown in FIG. 1, the air hand control input device includes a gyroscope 61, an angular velocity processor 62, a signal collecting switch 3, an interface chip 7, and a housing 8.

Wherein the housing 8 is an outer housing of the whole air hand control input device, accommodating other parts in the air hand control input device. The housing 8 in the embodiment is hemispherical, of course, it can also be designed to a shape suitable for human palm to operate according to human engineering. The interface chip 7 is used for communication with a terminal equipment. The concrete structure of the gyroscope 61 is as shown in FIG. 5.

The signal collecting switch 3 is electrically connected to the angular velocity processor 62 for generating a starting signal to drive the gyroscope 61 to start collecting the angular velocity value of the air hand control input device, as well as for generating an ending signal to enable the gyroscope 61 to stop collecting the angular velocity value. The signal collecting switch 3 can be either a micro switch or a combination of a pressure sensor and a pressure signal processor, etc.

If the signal collecting switch 3 is the micro switch, a user touches and presses the micro switch, the flat spring in the micro switch contacts a normally open contact to generate the starting signal and transmit the starting signal to the angular velocity processor 62; when the user does not touch the micro switch, the flat spring in the micro switch contacts a normally closed contact to generate the ending signal and transmit the ending signal to the angular velocity processor 62.

If the signal collecting switch 3 is the combination of the pressure sensor and the pressure signal processor, the user applies a pressure to the pressure sensor to generate a pressure signal containing a pressure value and transmit the pressure signal to the pressure signal processor. If the pressure signal processor judges that the pressure value is greater than the set pressure threshold, the starting signal is generated and transmitted to the angular velocity processor 62; while if the pressure signal processor judges that the pressure value is less than the set pressure threshold, the ending signal is generated and transmitted to the angular velocity processor 62.

The gyroscope 61 is connected with the angular velocity processor 62, and the angular velocity processor 62 is further connected with the interface chip 7 and the signal collecting switch 3. After the angular velocity processor 62 receives the starting signal transmitted by the signal collecting switch 3, the gyroscope 61 is controlled to start collecting the angular velocity value.

To be specific, the gyroscope 61 collects the angular velocity values (Δaₓ, Δv_{y}=Δa_{y}*T, Δa_{y}) of the air hand control input device on the x-axis, y-axis and z-axis of the three-dimensional space, and transmits the angular velocity signal containing the collected angular velocity values (Δaₓ, Δv_{y}=Δa_{y}*T, Δa_{y}) to the angular velocity processor 62.

As shown in FIG. 6, the angular velocity processor 62 uses the following formula to calculate a rotation angle ∠β of the air hand control input device on the xy plane, a three-dimensional rotation azimuth angle ∠α of the air hand control input device and a three-dimensional rotation angle ∠φ at the three-dimensional rotation azimuth angle according to the received angular velocity values of the air hand control input device on the three axes and a sampling period of the gyroscope 61.

To be specific, the rotation angle ∠β of the air hand control input device on the xy plane is calculated according to formula (1):

∠β=ω_{xy}*T=ω_{z}*T (1)

wherein, ω_{z} represents the angular velocity of the air hand control input device on the z-axis, ω_{xy} represents the rotation angular velocity of the air hand control input device on the xy plane, and T represents the sampling period of the gyroscope 61. As shown in FIG. 6, the angular velocity on the xy plane is that on the z-axis, therefore, ω_{xy}=ω_{z}. The rotation angle ∠β in the embodiment is used for controlling the rotation angle, on the xy plane of the display space, of the controlled object on the interface of the terminal equipment.

The three-dimensional rotation azimuth angle ∠α of the air hand control input device is calculated according to formula (2):

$$When {ω}_{x} > 0 , \\ ∠α = \frac{π}{2} + arctan \frac{{ω}_{y}}{{ω}_{x}} \\ When {ω}_{x} < 0 , \\ ∠α = \frac{3}{2} π + arctan \frac{{ω}_{y}}{{ω}_{x}} \\ When {ω}_{x} = 0 , {ω}_{y} > 0 , \\ ∠α = π \\ When {ω}_{x} > 0 , {ω}_{y} < 0 , \\ ∠α = 0 \qquad ( 2 )$$

Wherein, ωₓ represents the angular velocity of the air hand control input device on the x-axis, and ω_{y} represents the angular velocity of the air hand control input device on the y-axis. Furthermore, as shown in FIG. 6, the combined angular velocity of the angular velocity on the x-axis ωₓ and the angular velocity on the y-axis ω_{y} is calculated as ωₗ, so as to obtain the direction of the l-axis; and then the direction of a beam OE is obtained as the beam OE is perpendicular to the l-axis on the xy plane, and an angle between the beam OE and the positive direction of the x-axis is the three-dimensional rotation azimuth angle ∠α. The three-dimensional rotation azimuth angle ∠α is changed by following the change of the angular velocity on the x-axis ωₓ and the angular velocity on the y-axis ω_{y} of the air hand control input device. The three-dimensional rotation azimuth angle ∠α is used for controlling the three-dimensional rotation azimuth, on the xy plane of the display space, of the controlled object on the interface of the terminal equipment.

The three-dimensional rotation angle ∠φ of the air hand control input device at the three-dimensional rotation azimuth angle ∠α is calculated according to formula (3).

∠φ=ωₗ*T=\sqrt{ωₓ²+ω_{y}²}*T (3)

Wherein, ωₓ represents the angular velocity of the air hand control input device on the x-axis, ω_{y} represents the angular velocity of the air hand control input device on the y-axis, ω_{z} represents the angular velocity of the air hand control input device on the z-axis, and T represents the sampling period of the gyroscope. Furthermore, as shown in FIG. 6, the three-dimensional rotation angular velocity at the three-dimensional rotation azimuth angle ∠α is the rotation angular velocity ωₗ on the l-axis, therefore, ∠φ=ωₗ*T. The three-dimensional rotation angle ∠φ at the three-dimensional rotation azimuth angle ∠α is used for controlling the three-dimensional rotation angle at the three-dimensional rotation azimuth angle, on the xy plane of the display space, of the controlled object on the interface of the terminal equipment.

In the embodiment, the method for calculating the rotation angle of the air hand control input device on the xy plane, the three-dimensional rotation azimuth angle, and the three-dimensional rotation angle at the three-dimensional rotation azimuth angle is not limited to the method illustrated in the foregoing formulas, as long as the control on the movement of the controlled object in the display space of the terminal equipment by the movement of the air hand control input device has been reflected.

The embodiment further provides an air hand control input method, including the following steps of:

Step S11, collecting angular velocity values of the air hand control input device on the x-axis, y-axis, and z-axis via a gyroscope; and

Step S12, calculating an rotation angle on the xy plane, a three-dimensional rotation azimuth angle, and a three-dimensional rotation angle at the three-dimensional rotation azimuth angle of the air hand control input device, according to the angular velocity values and a sampling period of the gyroscope.

The gyroscope 61 in the embodiment may be a free ball bearing gyroscope, a liquid floated gyroscope, an electrostatic gyroscope, a laser gyroscope, and a capacitive gyroscope, etc., among which the capacitive gyroscope provided by InvenSense is preferred.

### Second Embodiment

As shown in FIG. 2, in addition to the components described in the first embodiment, the air hand control input device of the second embodiment further comprises an accelerometer 41 and an acceleration processor 42. The accelerometer 41 is connected with the acceleration processor 42, and the acceleration processor 42 is further electrically connected to the signal collecting switch 3 and the interface chip 7. The signal collecting switch 3 is further used for transmitting, to the acceleration processor 42, the starting signal for instructing the accelerometer 41 to start collecting the acceleration value and the ending signal for instructing the accelerometer 41 to stop collecting the acceleration value.

The acceleration processor 42 includes a storage module, used for storing the acceleration components of the air hand control input device on the x-axis, y-axis, and z-axis obtained by decomposing the acceleration value collected every time, and for storing the initial velocities of the air hand control input device on the x-axis, y-axis, and z-axis. The directions of the x-axis, the y-axis, and the z-axis have been previously set when the accelerometer leaves the factory. Generally, the directions of the three-axis are defined as follows: the air hand control input device is placed on the horizontal plane, the bottom surface of the air hand control input device is served as the xy plane, the front pointed by the device is the direction of the x-axis, the right direction perpendicular to the x-axis is the direction of the y-axis, and the direction perpendicular to the plane upward is the direction of the z-axis.

After receiving the starting signal from the signal collecting switch 3, the acceleration processor 42 instructs the accelerator 41 to start collecting the acceleration value of the air hand control input device.

The accelerometer 41 starts collecting the acceleration value of the air hand control input device in one sampling period according to the instruction of the acceleration processor 42, and transmits the acceleration signal containing the collected acceleration value to the acceleration processor 42. The acceleration processor 42 decomposes the received acceleration value into the acceleration components (aₓᵢ, a_{yi}, and a_{zi}) on the x-axis, the y-axis, and the z-axis, obtains the acceleration variation values (□ aₓ, □ a_{y}, and □ a_{z}) according to the previously-collected acceleration components (aₓᵢ₋₁, a_{yi-1}, and a_{zi-1}) in various directions, and calculates the velocity variation values (□ vₓ, □ v_{y}, and □ v_{z}) in various directions according to the acceleration variation values (□ aₓ, □ a_{y}, and □ a_{z}). The formulas are as follows:

□vₓ=□aₓ*T

□v_{y}=□a_{y}*T

□v_{z}=□a_{z}*T (4)

Wherein, □ aₓ is the acceleration variation value of the air hand control input device on the x-axis, and □ aₓ=aₓᵢ−aₓᵢ₋₁; □ a_{y} is the acceleration variation value of the air hand control input device on the y-axis, and □ a_{y}=a_{yi}−a_{yi-1}; □ a_{z} is the acceleration variation value of the air hand control input device on the z-axis, and □ a_{z}=a_{zi}−a_{zi-1}; T is the sampling period; □ vₓ is the velocity variation value of the air hand control input device on the x-axis, □ v_{y} is the velocity variation value of the air hand control input device on the y-axis, and □ v_{z} is the velocity variation value of the air hand control input device on the z-axis.

And then, the acceleration processor 42 calculates the displacement variation values of the controlled object on the three axes according to the stored initial velocities (vₓ₀, v_{y0}, and v_{z0}) on the x-axis, the y-axis, and the z-axis. The formulas are as follows:

$$Δ {s}_{x} = ( {v}_{x 0} * T + \frac{1}{2} * Δ {a}_{x} * {T}^{2} ) * {l}_{x} = Δ {s}_{x 1} * {l}_{x} \\ Δ {s}_{y} = ( {v}_{y 0} * T + \frac{1}{2} * Δ {a}_{y} * {T}^{2} ) * {l}_{y} = Δ {s}_{y 1} * {l}_{y} \\ Δ {s}_{z} = ( {v}_{z 0} * T + \frac{1}{2} * Δ {a}_{z} * {T}^{2} ) * {l}_{z} = Δ {s}_{z 1} * {l}_{z} \qquad ( 5 )$$

Wherein, Δsₓ₁ is the displacement variation value of the air hand control input device on the x-axis, lₓ is the proportionality coefficient of the x-axis displacement variation value, and Δsₓ is the displacement variation value, on the x-axis, of the controlled object on the interface of the terminal equipment.

Δs_{y1} is the displacement variation value of the air hand control input device on the y-axis, l_{y} is the proportionality coefficient of the y-axis displacement variation value, and Δs_{y} is the displacement variation value, on the y-axis, of the controlled object on the interface of the terminal equipment.

Δs_{z1} is the displacement variation value of the air hand control input device on the z-axis, l_{z} is the proportionality coefficient of the z-axis displacement variation value, and Δs_{z} is the displacement variation value, on the z-axis, of the controlled object on the interface of the terminal equipment.

Each of proportionality coefficients may be changed according to various practical situations. The three proportionality coefficients may be the same or not, as long as the displacement control on the controlled object by the movement of the air hand control input device has been reflected. For instance, if the moving distance of the controlled object is expected to increase, the proportionality coefficient may be increased.

Then, the acceleration processor 42 transmits the displacement variation signal containing Δsₓ, Δs_{y}, and Δs_{z} to the interface chip 7. The interface chip 7 transmits the displacement variation signal to the terminal equipment via the communication module. Δsₓ, Δs_{y}, and Δs_{z} are used for respectively controlling the displacement variation, on the x-axis, the y-axis and the z-axis of the display space, of the controlled object on the interface of the terminal equipment.

Then, the acceleration processor 42 calculates and stores the velocity values on the three axes of the air hand control input device measured at this time, according to the formulas vₓ₀=vₓ₀+Δvₓ, v_{y0}=v_{y0}+Δv_{y}, and v_{z0}=v_{z0}+Δv_{z}, so as to be served as the initial velocities when sampling next time. When the acceleration processor 42 receives the ending signal, the values of (vₓ₀, v_{y0}, v_{z0}) are reset.

Further, the acceleration processor 42 may also include a judgment module. In this case, the storage module is also stored with an acceleration threshold, which may be set as a matter of experience. The judgment module is used for judging whether the acceleration collected by the accelerometer 41 is greater than the acceleration threshold. Only when the acceleration is greater than the acceleration threshold, the acceleration is decomposed and the subsequent calculation is performed. This avoids the misoperation caused by user's movement including hand trembling.

The embodiment further provides an air hand control input method, including the following steps.

Step S21, the accelerometer collects the acceleration value of the air hand control input device, and transmits the acceleration signal containing the acceleration value to the acceleration processor.

Step S22, the acceleration processor decomposes the acceleration value into the acceleration components on the x-axis, the y-axis and the z-axis of the three-dimensional space.

Step S23, the acceleration processor obtains the acceleration variation values according to the acceleration components and the stored previously-collected acceleration components, obtains the velocity variation values of the air hand control input device on the three axes by multiplying the acceleration variation values by the sampling period, and then calculates the displacement variation values for controlling the displacement variations on the three axes of the controlled object on the interface of the terminal equipment according to the acceleration variation values, the velocity variation values, the sampling period, and the proportionality coefficients.

The accelerometer 41 in the embodiment may be a capacitive accelerometer, a bubble type accelerometer, and a pressure type accelerometer, among which the capacitive accelerometer is preferred.

### Third Embodiment

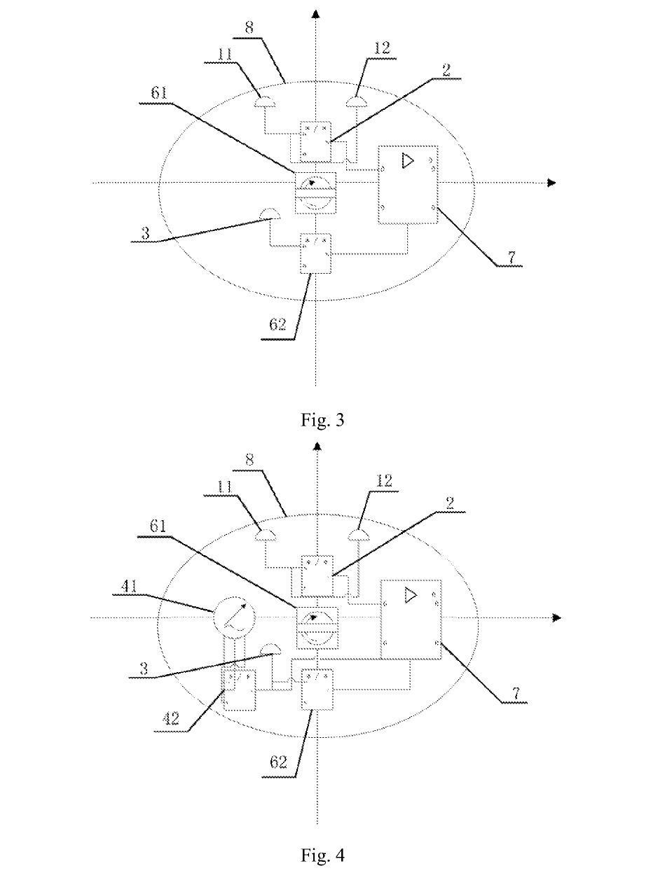

As shown in FIG. 3, in addition to the components described in the first embodiment, the air hand control input device of the third embodiment further comprises a left touch pressure signal collector 11, a right touch pressure signal collector 12, and a touch pressure signal processor 2. The left touch pressure signal collector 11 and the right touch pressure signal collector 12 are electrically connected to the touch pressure signal processor 2 respectively, and the touch pressure signal processor 2 is electrically connected to the interface chip 7.

In fact, there may be one or more touch pressure signal collectors arranged.

With sensing the externally applied force, the left touch pressure signal collector 11 and the right touch pressure signal collector 12 each generate the touch pressure signal containing the touch pressure information. The touch pressure signal includes a pressure value and an identifier of the touch pressure signal collector. The left touch pressure signal collector 11 and the right touch pressure signal collector 12 transmit the generated touch pressure signal to the touch pressure signal processor 2 respectively. The touch pressure signal processor 2 extracts the touch pressure information from the received touch pressure signals, and combines the information as an information set including two sets of touch pressure information. The information set is transmitted to the interface chip 7, and the interface chip 7 transmits the received information set to the terminal equipment. When only one touch pressure signal collector is set, the touch pressure signal processor 2 only transfers the received touch pressure signal to the interface chip 7.

In the embodiment, the touch pressure information is used for instructing the program in the terminal equipment to execute the corresponding action. For instance, when a play button of a player on the interface of the terminal equipment is controlled by the left touch pressure signal collector 11, the magnitude of the pressure value is corresponding to the playing speed, and the pressure of the N consecutive sampling periods is corresponding to popping up the next level of menu, etc. The identifier in the touch pressure information is used for indicating which one of the touch pressure signal collectors the information is originated from.

The touch pressure signal collector may be a piezoresistive pressure sensor, an inductive pressure sensor, a capacitive pressure sensor, a resonant pressure sensor, a resistance strain gauge type pressure sensor, a semiconductor strain gauge type pressure sensor, a capacitive acceleration sensor, and a micro switch, etc. Preferably, the piezoresistive pressure sensor is used as the touch pressure signal collector in the embodiment, as it has low price, higher precision and better linear performance.

The part of the housing 8 corresponding to the touch pressure signal collector is configured to be movable, and can be pressed down to contact the touch pressure signal collector to generate the touch pressure signal.

The embodiment further provides an air hand control input method, including the following steps.

Step S31, each of touch pressure signal collectors senses the force externally applied to the hand control input device, generates the touch pressure signal containing the touch pressure information, and transmits the touch pressure signal to the touch pressure signal processor. The touch pressure information includes the pressure value and the identifier of the touch pressure signal collector.

Step S32, the touch pressure signal processor transmits the touch pressure signal to the terminal equipment via the interface chip.

### Fourth Embodiment

As shown in FIG. 4, in addition to the components described in the second embodiment, the air hand control input device of the fourth embodiment further comprises a left touch pressure signal collector 11, a right touch pressure signal collector 12, and a touch pressure signal processor 2. The left touch pressure signal collector 11 and the right touch pressure signal collector 12 are electrically connected to the touch pressure signal processor 2 respectively, and the touch pressure signal processor 2 is electrically connected to the interface chip 7.

As the functions and principles of the added part are the same as those of the third embodiment, they will not be elaborated in details herein.

Those having ordinary skills in the art may understand that all or part of flows of the foregoing embodiments may be finished by the hardware related to the computer program instruction. The foregoing program may be stored in a computer-readable storage medium. The program may include the flows of the foregoing various embodiments during execution. Wherein, the foregoing storage medium may be a disk, an optical disk, a READ-Only Memory (ROM) or a Random Access Memory (RAM), etc.

The above description is merely detailed implementation manner of the present disclosure, but not intended to limit the protection scope of the present disclosure. Any changes or replacements easily figured out by those skilled in the art without departing from the technical scope disclosed by the present disclosure shall all fall within the protection scope of the present disclosure. Therefore, the protection scope of the present disclosure shall be subjected to the protection scope of the claims.

### PRACTICAL APPLICABILITY

The air hand control input equipment provided according to the embodiments of the present disclosure can be applied in the field of the computer peripherals. The air hand control input device can be operated in the air without a carrier. Both the device and method can not only realize the control of the traditional two-dimensional control function, but also can realize the three-dimensional control of the controlled part, thus providing all-around control of two dimensions and three dimensions on the interface.

What is claimed is:

1. An air hand control input device, comprising:
a housing, and
an interface chip, arranged inside the housing for communication with a terminal equipment,
wherein the air hand control input device further comprises:
a gyroscope, arranged inside the housing for collecting angular velocity values of the air hand control input device on x-axis, y-axis, and z-axis of a three-dimensional space and transmitting an angular velocity signal containing the angular velocity values; and
an angular velocity processor, arranged inside the housing and connected with the gyroscope and the interface chip, the angular velocity processor being adapted to calculate a rotation angle on the xy plane, a three-dimensional rotation azimuth angle, and a three-dimensional rotation angle at the three-dimensional rotation azimuth angle of the air hand control input device, according to the angular velocity values contained in the angular velocity signal from the gyroscope and a sampling period of the gyroscope.

2. The air hand control input device according to claim 1, further comprising:
a signal collecting switch, arranged inside the housing and connected with the angular velocity processor, the signal collecting switch being adapted to generate a starting signal for instructing the gyroscope to start collecting the angular velocity values and an ending signal for instructing the gyroscope to end collecting the angular velocity values.

3. The air hand control input device according to claim 2, further comprising:
an accelerometer, arranged inside the housing for collecting an acceleration value of the air hand control input device and transmitting an acceleration signal containing the acceleration value; and
an acceleration processor, connected with the interface chip, the accelerometer, and the signal collecting switch, the acceleration processor being adapted to calculate displacement variation values of the air hand control input device on the x-axis, y-axis, and z-axis of the three-dimensional space, according to the acceleration value contained in the acceleration signal from the accelerometer and a sampling period of the accelerometer, and transmit the calculated displacement variation values to the interface chip.

4. The air hand control input device according to claim 3, wherein the acceleration processor comprises:
a storage module for storing acceleration components of the air hand control input device on the x-axis, y-axis, and z-axis of the three-dimensional space, which are obtained by decomposing the acceleration value collected every time, and for storing initial velocities of the air hand control input device on the x-axis, y-axis, and z-axis of the three-dimensional space; and
a computation module for calculating a displacement variation value according to the acceleration components, the initial velocities, the sampling period of the accelerometer, and a proportionality coefficient, the displacement variation value being used to control displacement variations, on x-axis, y-axis, and z-axis of a display space, of a controlled object on an interface of the terminal equipment.

5. The air hand control input device according to claim 4, wherein the storage module is further stored with an acceleration threshold, and
the acceleration processor further comprises:
a judgment module for judging whether the acceleration value is greater than the acceleration threshold, and if the acceleration value is greater than the acceleration threshold, instructing the computation module to start the calculation.

6. The air hand control input device according to any one of claims 1 to 5, further comprising:
at least one touch pressure signal collector, arranged on a surface of the housing for sensing an force externally applied to the air hand control input device, and generating and transmitting a touch pressure signal, the touch pressure signal containing the sensed pressure value and an identifier identifying the touch pressure signal collector; and
a touch pressure signal processor, electrically connected with the touch pressure signal collector and the interface chip, the touch pressure signal processor being adapted to extract the pressure value and the identifier from the touch pressure signal, and transmit the extracted pressure value and identifier to the terminal equipment via the interface chip.

7. The air hand control input device according to any one of claims 1 to 5, wherein the signal collecting switch comprises a pressure sensor.

8. The air hand control input device according to any one of claims 1 to 5, wherein the signal collecting switch comprises a micro switch.

9. An air hand control input method, comprising the following steps of:
collecting angular velocity values of an air hand control input device on x-axis, y-axis, and z-axis of a three-dimensional space via a gyroscope; and
calculating a rotation angle on the xy plane, a three-dimensional rotation azimuth angle, and a three-dimensional rotation angle at the three-dimensional rotation azimuth angle of the air hand control input device, according to the angular velocity values and a sampling period of the gyroscope.

10. The air hand control input method according to claim 9, further comprising the following steps of:
collecting an acceleration value of the air hand control input device via an accelerometer;
decomposing the acceleration value into acceleration components of the air hand control input device on the x-axis, y-axis, and z-axis of the three-dimensional space; and
calculating a displacement variation value according to the acceleration components, initial velocities of the air hand control input device on the x-axis, y-axis, and z-axis of the three-dimensional space, a sampling period of the accelerometer, and a proportionality coefficient, the displacement variation value being used to control displacement variations, on x-axis, y-axis and z-axis of a display space, of a controlled object on an interface of the terminal equipment.
